(19) United States
(12) Patent Application Publication
(10) Pub. No.: US 2015/0051956 A1
(43) Pub. Date: Feb. 19, 2015

(54) SIMPLE PRICING BY PRICE-DIFFERENCE REGULARIZATION

(71) Applicants: Palo Alto Research Center Incorporated, Palo Alto, CA (US); Xerox Corporation, Norwalk, CT (US)

(72) Inventors: Christopher R. Dance, Grenoble (FR); Onno R. Zoeter, Grenoble (FR); Daniel H. Greene, Sunnyvale, CA (US)

(73) Assignees: Palo Alto Research Center Incorporated, Palo Alto, CA (US); Xerox Corporation, Norwalk, CT (US)

(21) Appl. No.: 13/969,762

(22) Filed: Aug. 19, 2013

(51) Int. Cl. G06Q 30/02

(52) U.S. Cl. CPC G06Q 30/0283
USPC 705/7.35

(57) ABSTRACT

A method and system for determining an optimized price schedule that controls the simplicity of a price schedule while maintaining efficiency in terms of welfare. A welfare function and a simplicity metric representing a simplicity of price schedules are determined. A full objective, corresponding to a comparison of the welfare with respect to the simplicity of each price schedule is determined and an optimized price schedule, representing the schedule having the highest computed full objective, is output.

### BACKGROUND

The following relates to simplification of complex interactions, optimization of price schedules, and so forth.

Large cities generally offer substantial on-street parking, which can often be an expensive proposition for the average driver. Attempts have been made to assist cities and drivers in collecting revenues and providing parking. For example, the installation of parking sensors in cities such as Los Angeles and San Francisco promises a better trade-off between prices and the ease of finding a parking space. These sensors track the occupancy (exactly how many vehicles are parked) of each block face (the portion of a street that lies between two blocks available for parking). The purpose is to set prices dynamically so that the occupancy of each block face equals some occupancy target, such as 70% or 80% full, throughout the day. This dynamic setting of prices corresponds to a timetable of prices that is fixed in advance and that is changed every few weeks. This type of setting is not analogous to hard to predict minute-by-minute price changes that are common for air fares, which would make drivers' lives even more complex.

For example, using one week, there are 168 hours, each of which may have different pricing schedules associated with it, e.g., different pricing for parking in the evenings than during the day, higher prices during rush hour, lower/higher weekend prices, etc. Furthermore, each particular parking space may have its own price, depending again on the time of day, proximity to a venue/building, or the like. This type of price schedule is complicated not only from the standpoint of the parking operators, but also the consumer, who may have to read complicated pricing schedules quickly to determine whether or not to park at a given location. For example, frustration would likely arise should a driver park on a street that usually costs $5 per hour and as the driver went to pay the meter, the price increased to $15 per hour due to the time of day.

Controlling prices for a scarce resource is commonly referenced as demand management. Demand management uses price schedules to maximize the efficient use of scare resources. In the context of on-street parking, demand management can have numerous benefits. For example, in places where prices are lowered there is better utilization of existing space. Similarly, in places where prices are raised, finding a parking space becomes easier, provided the motorist is willing to pay the increased price. This variation in pricing for parking spaces may result in fewer vehicles circling around looking for a space, slowing down other traffic, causing congestion, and pollution, as well as wasting other drivers' time. Furthermore, as prices for parking spaces increase, some drivers may shift to more environmentally friendly modes of transport, e.g., car pools, public transport or cycling. Depending on the choice of specific circumstances of a city, both increases and decreases in price can result in more revenue for a city. For instance, if prices are lowered, there is typically an increase in demand which may offset the lower price paid per driver. However, if people must understand price schedules prior to changing their behavior, any complex price schedule may fail to support efficient use of the resource.

Previous attempts to provide dynamic pricing in a fashion that is simple for drivers to understand, such as the occupancy thermostat, merely raise prices when the average occupancy over the last month was significantly above a preset target occupancy level and lowers prices when the average occupancy over the last month was significantly below the preset target occupancy. For instance, the occupancy thermostat approach may raise prices by $0.50 per hour if occupancy was over 80% during the previous month, while lowering prices by $0.50 if occupancy was below 60% during the last month.

As will be appreciated, this approach to dynamic pricing includes several inherent limitations. A first limitation is reflected in that the occupancy may oscillate by a substantial amount. For example, when there are two nearby block faces, respectively priced initially at $3.50 (first block face) and $3.00 (second block face) per hour and people are parking for about six hours, users may take advantage of the lower-priced faces. So, if during one month the occupancies of the block faces are 50% (@$3.50) and 90% (@$3.00), then the prices will adjust downward by $0.50 to $3 per hour for the first block face and adjust upward by $0.50 to $3.50 per hour for the second block face during the next month, leading to the price oscillation.

An additional and more significant limitation inherent in the occupancy thermostat is that it is not possible to predict future occupancy given large but foreseeable variations. For example, predictions based on the impact of road closures, seasonal variations, sporting events, holidays, and the like, are difficult to make accurately to set prices accordingly. In addition, the inability to make price changes that trade off the costs and benefits of congestion, revenue to the city, illegal parking, and the like, further limits the efficiency of the occupancy thermostat methodology. It should also be noted that the occupancy thermostat fails to provide guidance as to the appropriate occupancy targets for each block face, set of block faces, etc. To facilitate such predictions, various other factors would need to be taken into account, e.g., how much people value their on-street parking spaces relative to other options such as public transport and off-street parking, as well as gauging the impact of occupancy targets on local businesses.

To address such limitations, it would be advantageous to build models of how demand varies with price. The dynamic pricing problem presents several challenges, such as modeling how people choose parking spaces. It is possible to make a choice model that accounts for willingness to pay and willingness to walk. However, to make reliable predictions, the immense flexibility that drivers have about where, when, for how long they stay, and for what portion of their stay they are parked legally should be understood. Additionally, it should be recognized that populations react gradually, rather than instantly to price changes, and that drivers may revise their decisions because the block face they wished to park on is currently fully occupied.

An estimate of the parameters of such a model from a history of observations and optimize prices can be made. These tasks are computationally difficult for a large city because of the large number of possible choices of location, arrival time and parking duration, and because the whole system has a complicated dependence on its own history. For instance, the actual behavior of driver A, who arrives at 11 am, depends on the behavior of drivers B, who arrived at 9 am, and C, who arrived at 10 am, since those drivers may have fully occupied the block face where driver A first wished to park.

Thus, it would be advantageous to provide a method and system to assist in optimizing price schedules that take into account the complexity of the schedule and other costs/benefits that may be associated with the pricing schedule.

### BRIEF DESCRIPTION

In accordance with one aspect of the exemplary embodiment, a method for selecting an optimized price schedule is provided. The method includes providing a simplicity metric for computing a simplicity term based on weighted differences between prices in a price schedule. The method also includes providing a welfare function for computing a welfare term corresponding to the price schedule. For a plurality of price schedules, the method includes evaluating the simplicity term of each price schedule in accordance with the simplicity metric, computing a welfare term for each price schedule in accordance with the welfare function, and determining a difference between the welfare term and the simplicity term for each price schedule. The method further includes outputting an optimized price schedule selected from the plurality of price schedules, the selected one of the plurality of price schedules being selected in accordance with the determined respective differences.

According to another aspect, an optimized price schedule selection system is provided. The system includes a processor and a simplicity metric component that is configured to compute a simplicity term based on weighted differences in a price schedule using a simplicity metric. The system also includes a welfare component that is configured to compute a welfare term corresponding to the price schedule using a welfare function, the welfare function representative of a quantification of a price schedule relative to a selected target. In addition, the system includes memory in communication with the processor, which stores instructions which are executed by the processor for evaluating the simplicity term of each price schedule of a plurality of price schedules in accordance with the simplicity metric. The instructions also include computing a welfare term for each price schedule of the plurality of price schedules in accordance with the welfare function, and computing a full objective of each price schedule as a function of the computed welfare term and simplicity term. In addition, the instructions are executed by the processor for outputting an optimized price schedule corresponding to a price schedule having a highest computed full objective.

According to another aspect, a method for determining an optimized price schedule includes providing a simplicity metric for computing a simplicity term based on a price schedule. The method further includes providing a welfare function for computing a welfare term corresponding to the price schedule. At least one parameter associated with the simplicity metric is then selectively optimized. The welfare term is maximized with respect to the simplicity metric having at least one selectively optimized parameter associated therewith. A new price schedule associated with the maximized welfare term is then output.

### BRIEF DESCRIPTION OF THE DRAWINGS

FIGS. 1A-1B are a functional block diagram of a system for selecting an optimized price schedule in accordance with one aspect of the exemplary embodiment.

FIG. 2 is a flow chart which diagrammatically shows the defining of an optimization problem associated with a price schedule used in a method for selecting an optimized price schedule in accordance with one aspect of the exemplary embodiment.

FIG. 3 is a flow chart which diagrammatically shows the optimization of a price schedule used in a method for selecting an optimized price schedule in accordance with one aspect of the exemplary embodiment.

FIG. 4 illustrates plots depicting results of an example implementation of the systems and methods for selecting an optimized price schedule in accordance with one aspect of the exemplary embodiment.

FIG. 5 illustrates additional plots depicting results of an example implementation of the systems and methods for selecting an optimized price schedule.

### DETAILED DESCRIPTION

One or more implementations of the subject application will now be described with reference to the attached drawings, wherein like reference numerals are used to refer to like elements throughout.

As described herein, there is provided a method for selecting a price schedule that optimizes, (e.g., maximizes) a weighted sum of welfare and a simplicity metric. The simplicity metric models costs associated with human understanding and reasoning with respect to a price schedule. As such, the aforementioned costs suitably increase as a schedule becomes more complex. Various embodiments described hereinafter use the pricing of parking as one example implementation of the systems and methods described herein. Additionally, the subject systems and methods include a specific optimization process that combines iterative thresholding, multi-stage convex relaxation and a transfer function, while applying them to price differences.

In the following, the terms “optimization,” “minimization,” and similar phraseology are to be broadly construed as one of ordinary skill in the art would understand these terms. For example, these terms are not to be construed as being limited to the absolute global optimized value, absolute global minimum, and so forth. For example, minimization of a function may employ an iterative minimization algorithm that terminates when a stopping criterion is met, which may be before an absolute minimum is reached. It is also contemplated for the optimized or minimum value to be a locally optimized or local minimum value.

It will be appreciated that the subject systems and methods described hereinafter provide pricing schedules that offer an improved trade-off between welfare and simplicity in contrast to manual construction of pricing schedules, with substantially less costly human intervention. With respect to the example implementation regarding parking, welfare improvement may correspond to an increased probability of finding a space for people with high valuations for a space, a decreased walking distance from parking space to final destination, as well as a decrease in congestion due to users cruising for a space, or other welfare parameters. Improved schedule simplicity corresponds to a reduced time for a human to read a schedule and make a transportation decision.

It will be appreciated that a simpler price schedule in accordance with the systems and methods set forth herein enable the ability to include more information about nearby prices on small maps while retaining readability. That is, with the increase in mobile computing, e.g., smart phones, and personal navigation devices, drivers are increasingly informed of parking prices through the screens of such mobile computing/navigation devices. Furthermore, informing drivers of parking prices may involve utilizing stickers, placed on meters, detailing the price schedule of the associated space. The amount of space available to convey information to a driver on such stickers is minimal and a simpler price schedule is thus better able to be presented on such stickers.

As previously discussed, demand management uses price schedules to maximize the efficient use of scarce resources. However, if people have to understand price schedules before changing their behavior, complex price schedules may fail to support efficient use. Thus, the subject systems and methods may be implemented so as to control the simplicity of price schedules while maintaining efficiency in terms of welfare. Accordingly, the embodiments set forth in greater detail below include outputting price schedules that provide both high efficiency and simplicity, are tractable, repeatable, easy to understand and easy to implement. While discussed in terms of parking, they are applicable to a variety of other pricing problems.

### DEFINITIONS

A price schedule, as used herein, corresponds to a mapping from some set of quantifiable parameters to a price. For example, in the case of parking, it may be a mapping from location, arrival time, and duration to a price for a parking space per unit of time. Other factors may also influence a parking price schedule, such as timing of concerts, sporting events, conventions, assemblies, and the like. A price schedule can comprise a set of tables, each table mapping a combination of the parameters, such as day-of-the-week, block face, and hour of the day to a price.

Welfare, as used herein, is a sum over buyers to whom a resource is allocated of those buyers' valuations for that resource (the maximum amount a person would pay to have the resource). In some embodiments, welfare may include an extra term corresponding to the revenue or profit of a seller. It will be appreciated that valuations may or may not be directly observed, and when not directly observed, may be indicated as an expectation of buyers' valuations according to a statistical model of the distribution of valuations. Stated another way, welfare may be the sum of peoples' valuations for what they get allocated. Thus, a price schedule that achieves a high welfare is identified as an efficient price schedule. For example, in the context of pricing schedules for parking, driver A and driver B desire to park in a parking space of a downtown block face for one hour. The valuation attributed to the parking space may be different for driver A than for driver B, e.g., driver A places a valuation for the parking space at two dollars an hour while driver B places and a valuation for the parking space at three dollars an hour. In this simplistic example, the welfare may be defined as the sum of people's valuations for the parking spaces, i.e., $2.00 and $3.00 (if both park) resulting in a welfare of $5.00. Thus, the welfare in this example context is the sum of driver A's and driver B's valuation of the respective parking spaces.

A welfare function, as applied in a price setting context, is expressed as a function that quantifies the efficiency of a price schedule relative to some measurable target, e.g., occupancy, income, or the like. In accordance with one embodiment, the welfare function represents a deviation of a price schedule from some target schedule.

Simplicity, as applied to a price schedule, provides one metric for determining the welfare, and thus the efficiency of the price schedule. For example, when provided with a “simpler” price schedule, the time required for a user to read enough of the schedule to arrive at a decision is shorter than a more “complex” price schedule. The lesser amount of time may be manifest as a reduced time lag between price changes and “equilibrium demand” or as an improvement in measures of predictability of changes in demand in response to price changes. It might also manifest itself in people protesting less about schedule complexity. With respect to the parking example referenced above, the metric may readily be adapted to the resource in question, e.g., to trade off simplification for time-of-day, block face, day-of-week, new-price-versus-old-price and digits in the price. In such an example, this metric may be easily explained to and understood by city managers and politicians or others responsible for price schedules, it may also be readily implemented by those responsible for implementing price schedule changes, such as parking meter vendors. For example, a simple schedule may have a set block of time at a set price while the next block of time is at the same or different price. In contrast a complex price schedule may vary the cost per unit of time such that a first hour costs X amount while the second hour costs X plus Y amount, the third hour costs X plus Y plus Z and so forth.

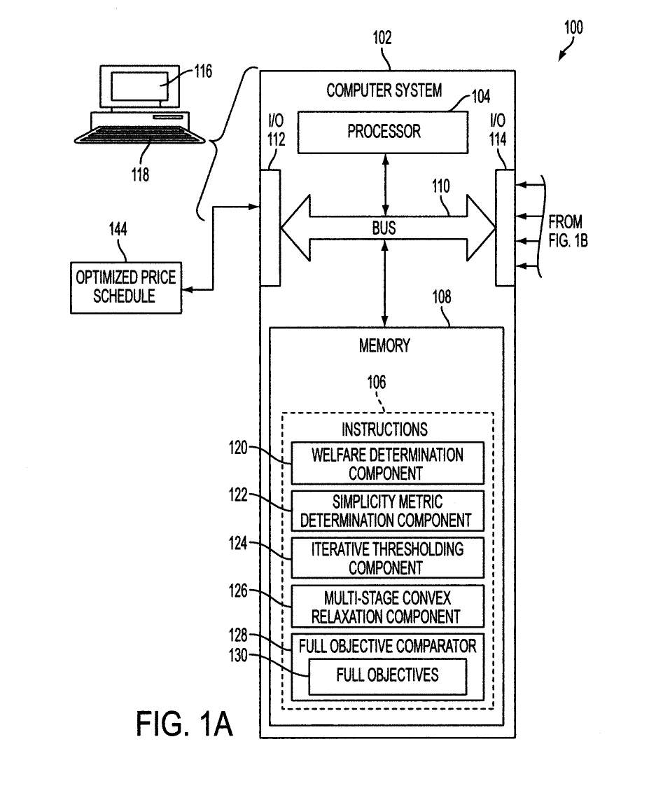

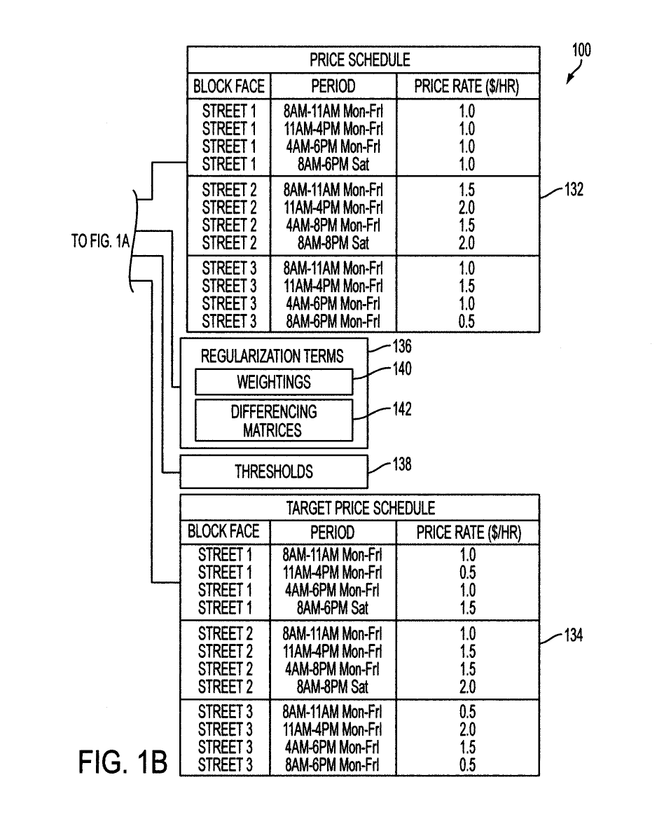

Referring now to FIGS. 1A-1B, there is shown a functional block diagram of a computer-implemented system 100 for optimized price schedule selection. It will be appreciated that the various components depicted in FIGS. 1A-1B are for purposes of illustrating aspects of the subject application, and that other similar components, implemented via hardware, software, or a combination thereof, are capable of being substituted therein.

The price schedule selection system 100 is capable of implementation using a distributed computing environment, such as a computer network, which is representative of any distributed communications system capable of enabling the exchange of data between two or more electronic devices. Such a computer network may include, for example, a virtual local area network, a wide area network, a personal area network, a local area network, the Internet, an intranet, or the any suitable combination thereof. The computer network may include physical layers and transport layers, e.g., Token-Ring, Ethernet, or other wireless or wire-based data communication mechanisms. Furthermore, while depicted in FIGS. 1A-1B as a networked set of components, the system and method are capable of implementation on a stand-alone device adapted to perform the methods described herein.

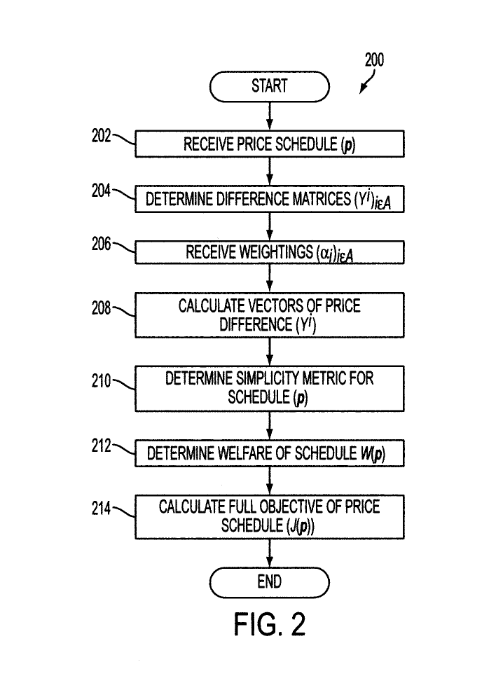

As shown in FIGS. 1A-1B, the price schedule selection system 100 includes a computer system 102 having a processor 104, which is capable of implementing at least a portion of the exemplary method described in FIG. 2 by execution of software processing instructions 106 which are stored in memory, such as memory 108, which is communicatively coupled to the processor 104. The computer system 102 may include a computer server, workstation, personal computer, combination thereof, or any other computing device. The computer system 102 may further include hardware, software, and/or any suitable combination thereof, configured to interact with an associated user, a networked device, networked storage, remote devices, or the like. The processor 104 may also control the overall operations of the of the computer system 102.

The instructions 106 include a welfare determination component 120 that determines a welfare associated with a particular price schedule 132. As discussed above, the price schedule 132 represents a mapping from some set of parameters to a price. The welfare determination component 120 may calculate the welfare of a particular price schedule 132 using a variety of formulae, but generally determines an expected valuation that a set of customers have with respect to the particular price schedule 132. For example, the welfare of a particular price schedule 132 may be based upon its relationship with a target price schedule 134. The functioning of the welfare determination component 120 will be better understood in conjunction with FIGS. 2-5, discussed in greater detail below.

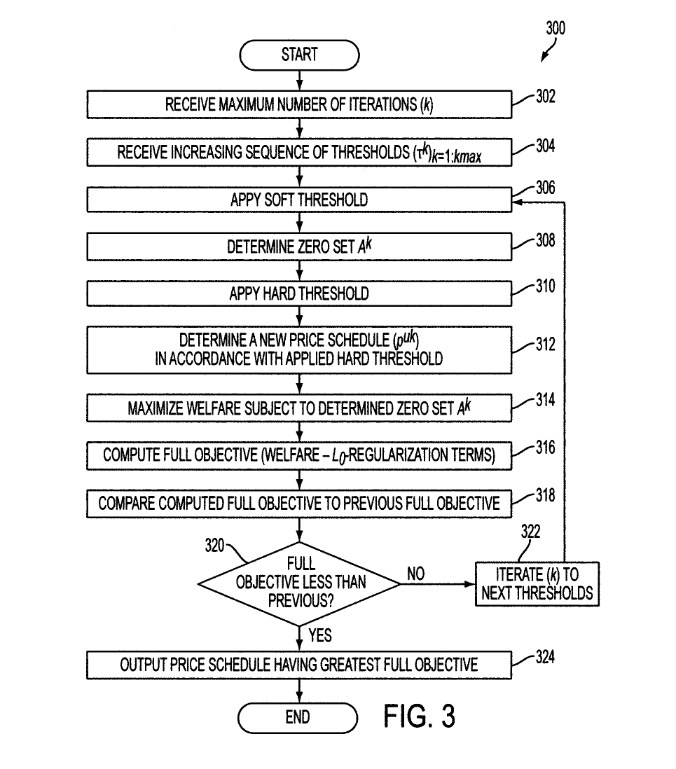

The instructions 106 may also include a simplicity metric determination component 122 that quantifies the simplicity of a price schedule 132 using regularization terms 136. The regularization terms 136 may include weightings 140 and differencing matrices 142, the generation of which is discussed below with respect to FIGS. 2-3. The simplicity determination component 122 determines the simplicity of the price schedule 132 by quantifying and penalizing the schedule 132 based upon its complexity, e.g., based on differences between pairs of specific components of the price schedule 132. The simplicity metric determination component 122 outputs a simplicity metric as discussed in greater detail below with respect to FIGS. 2-5.

As depicted in FIGS. 1A-1B, the instructions 106 of the computer system 102 may further include an iterative thresholding component 124 that applies an increasing sequence of soft and hard threshold functions (“thresholds”), which are illustrated in FIGS. 1A-1B as the thresholds 138 and described more fully below. In one embodiment, the iterative thresholding component 124 applies the sequence of soft thresholds to determine a new zero-set of price differences between the current price schedule and a target price schedule, while the sequence of hard thresholds is applied to maximize the welfare with respect the new zero-set, thus allowing for the generation of an optimized price schedule 144. Operating in conjunction with the iterative thresholding component 124 is a multi-stage convex relaxation (MSCR) component 126 that applies MSCR to assist in approximating the zero-set and to ease in the maximization of welfare with respect to simplicity, discussed in greater detail below with respect to FIGS. 2-5.

The instructions 106 may further include a full objective comparator 128 that operates in conjunction with the processor 104 to calculate and compare full objectives 130 associated with price schedules 132 and 144. The comparator 128 may facilitate the calculation of a value (e.g., full objective) 130 for each price schedule 132, 144 and thereafter facilitate the determination of the price schedule 144 having the optimal (e.g., highest) value, as set forth in detail below.

The output of the system 100 may be an optimized new price schedule 144 that corresponds to a price schedule having components that maximize the welfare subject to providing simplicity. According to one aspect, the optimized price schedule 144 has the highest full objective 130 over multiple iterations of the thresholds 138. That is, the optimized price schedule 144 may include an adjusted mapping from a set of parameters to a price which is more simplistic than the original price schedule 132, while maintaining or increasing efficiency with respect to welfare. It will be appreciated that the welfare determination component 120, the simplicity metric determination component 122, the iterative thresholding component 124, the multi-stage convex relaxation component 126, and the full objective comparator 128, as discussed in greater detail below, which are capable of being implemented via hardware, software, or combination thereof.

Computer system 102 may also include one or more interface devices 112, 114 for communicating with external devices or to receive external input. The I/O interface 112 may communicate with one or more of a display device 116, for displaying information to users, such as an optimized price schedule 144, and a user input device 118, such as a keyboard or touch or writable screen, for inputting text, and/or a cursor control device, such as mouse, trackball, or the like, for communicating user input information and command selections to the processor 104. The I/O interface 112 may receive an initial price schedule 132, a target price schedule 134, regularization terms 136, and thresholds 138, as are discussed in greater detail below. The various components of the computer system 102 may be all connected by a data/control bus 110.

The memory 108 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. In another embodiment, the memory 108 may further correspond to any mass storage device(s), for example, magnetic storage drives, a hard disk drive, optical storage devices, flash memory devices, or a suitable combination thereof. The network interface(s) 112, 114 allow the computer to communicate with other devices via a computer network, and may comprise a modulator/demodulator (MODEM). Memory 108 may store data the processed in the method as well as the instructions for performing the exemplary method.

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the computer 102, executes instructions stored in memory 108 for performing the method outlined in FIG. 2.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Turning now to FIG. 2, there is shown a flow chart 200 illustrating an exemplary method defining an optimization problem for use in determining an optimized price schedule. FIG. 3, discussed below, illustrates a flow chart 300 applying a specific optimization component so as to output an optimized price schedule. As will be appreciated, the steps of the method need not all progress in the order illustrated and fewer, more, or different steps may be performed. While reference is made herein to the computer system 102, other computer systems are also capable of implementation and use in accordance with the method of FIG. 2.

Defining of an optimization problem associated with the method 200 may begin with the receipt of an initial price schedule (p) 132 by the computer system 102, or the system 102 may arbitrarily generate an initial price schedule (p) 132. In the example illustrated in FIG. 2, it will be appreciated that the problem to be identified therein corresponds to determining the simplicity of the initial price schedule (p) 132 by modeling that when neighboring prices (on the initial price schedule (p) 132) differ in any way, a buyer may incur an extra cost in thinking about this difference. Thus, a function for computing the simplicity of the initial price schedule (p) 132 and subsequent price schedules is provided.

As shown in FIG. 2, the computing of the simplicity of the initial price schedule (p) 132 is accomplished in terms of a set of difference matrices (Yⁱ)_{iεA} 142, determined at 204 and weightings ((αᵢ)_{iεA}) 140, which are received at 206, respectively. In accordance with one embodiment, the weightings ((αᵢ)_{iεA}) 140 (and other parameters) may be manually tuned to give sensible results in the eyes of the person in charge; or more scientifically, the results for different weightings ((αᵢ)_{iεA}) 140 (and other parameters) may be shown to citizens, their opinions may then be solicited and their ability to recall the schedules for different settings would be tested. The weightings ((αᵢ)_{iεA}) 140 (and other parameters) can also be estimated from constraints suggested by city managers. For example, if a city manager requires that both sides of a street have the same price, assuming that to do otherwise would be too complicated, then the subject systems and methods may interpret this requirement as a lower bound on the weighting ((αᵢ)_{iεA}) 140 corresponding to price difference as a function of distance.

The difference matrices (Yⁱ)_{iεA} 142 may correspond to differences between prices in a target price schedule 134 and an initial price schedule (p) 132. The set of weightings ((αᵢ)_{iεA}) 140 may correspond to weights of variables (such as time, duration, cost, etc.) that are adjustable on the price schedule (p) 132, or the like. At 208, vectors of price differences (yⁱⱼ) are calculated. That is, the set of difference matrices ((Yⁱ)_{iεA}) 142 and weightings ((αᵢ)_{iεA}) 140, are applied to the initial price schedule (pε [symbol] ⁿ) 132, such that the product:

yⁱ:=Yⁱp

consists of a vector of price differences (yⁱ). Thus, the j^{th} component of the vector is of the form:

yⱼⁱ:=p_{c}_{ⱼ}−p_{d}_{ⱼ}

for some components (cⱼ, dⱼ) of the schedule (p) 132. The size of the difference vectors yⁱ may vary with index i, for instance corresponding to differences in prices along different physical dimensions of the schedule (p) 132. In one example, the weightings ((αᵢ)_{iεA}) 140 may be modified by an associated user to reflect changes in constraints to the price schedule (p) 132, e.g., changes in price per quantity, price per time, or other such variable elements.

At 210, the simplicity metric (S) for schedule (p) 132 may be determined as a function of weightings ((αᵢ)_{iεA}) 140 and difference matrices (Yⁱ)_{iεA} 142, e.g., in accordance with the equation:

$$S ( p ) = {\sum }_{i ∈ A} {α}_{i} {‖ {Y}^{i} p ‖}_{0}$$

where for a vector (y) the L₀-norm is ∥y∥₀:=0 if y=0 and 1 otherwise. i.e., the simplicity term is the sum of the weighted normalized difference vectors, over all the price schedule matrices.

According to one embodiment, the weightings (αᵢ) 140 include monetary units. In such an embodiment, a high value for a weighting (αᵢ) 140 may indicate that that the corresponding type of simplification is of particular importance. Furthermore, the weighting coefficients (αᵢ) 140 in the simplicity metric (S(p)) may be set to functions that increase with the demand for a given time or place, to reflect the number of people considering a particular aspect of a schedule 132. Time and locations may be divided into smaller or larger units and differences may be measured not just between adjacent days, hours and block faces, but also between any pairs of days, hours or locations.

At 212, the welfare (W) of the input schedule (p) 132 is determined, i.e., the welfare function (W(p)). Continuing with the equation set forth above, the welfare term (W) may be described by a function W: [symbol] ⁿ→ [symbol] which maps a price schedule pε [symbol] ⁿ to a monetary quantity. The influence of the price schedule (p) 132 on the welfare function (W(p)) may be via an integral of the price between an arrival and departure time, as is preferably the case for parking. The schedule 132 may further include a base payment which may be paid irrespective of the duration for which a resource is used. A full objective formula (J(p)) 130 associated with the price schedule (p) 132 may then be calculated at 214. According to one embodiment, the full objective (J(p)) 130 of the price simplification method is the difference between welfare (W(p)) and the simplicity metric (S(p)), i.e.:

$$J ( p ) := W ( p ) - {\sum }_{i ∈ A} {α}_{i} {‖ {Y}^{i} p ‖}_{0}$$

In this full objective (J(p)) 130, the simplicity metric (S(p)) may appear as a set of regularization terms 136, i.e., extra costs that correspond to the complexity of a price schedule (p) 132. In the context of pricing schedules, a regularization term 136 may be defined as a quantification of non-acceptance and penalization of the differences between pairs of specific components of the price schedule (p) 132. Thus, the simplicity metric (S(p)) takes into account that any difference in the price schedule (p) 132 may require an effort to be understood by the user and explained by the decider and as such may contribute negatively to the full objective J(p) 130. It will be appreciated that the identified optimization problem may therefore correspond to maximizing (J(p)) 130 with respect to (p) 132. Various constraints may also be applied, e.g., constraints such as upper and lower bounds on each price in the input schedule (p) 132.

Additional constraints on price schedules may be included in the framework. Furthermore, some regularization terms may also be included directly in the full objective (J(p)) 130, while others are included in the constraints. For example, a first type of additional constraint may relate to allowing and disallowing specific price changes. For instance, parking managers may want the price changes only at certain times, e.g., once in the morning at 7:00 AM and in the evening at 7:00 PM. Another example may relate to spatial changes, where the managers may wish to keep existing districts, or draw districts based on other criteria. Such constraints can be included in the given framework in at least three ways. First, by appropriate selection of the set of variables (αᵢ) 140, second by selection of the optimization variable, i.e., by making the schedule only include times (t) at which changes are allowed, and third by including times at which changes are not allowed in a constraint set, i.e., where optimizations take place, subject to constraints on such prices being equal.

A second type of additional constraint may relate to the maximum number of changes allowed. For instance, parking managers may wish to allow only two changes per day at unspecified times. In some instances, these constraints can be written by requiring that the sum of the regularization terms is less than some constant. T. Zhang. Analysis of Multi-stage Convex Relaxation for Sparse Regularization. Journal of Machine Learning Research, vol. 11, pp. 1081-1107, 2010, the entirety of which is incorporated by reference herein, calls this the “constrained formulation” in Eq. 2 therein, and gives a modified version of multi-stage convex relaxation (MSCR) in Section 2.4, which replaced the sum of relaxed regularization terms by a non-linear constraint on the sum of relaxed regularization terms. MSCR is discussed in greater detail below. In other instances, such constraints may require that a large number of specific regularization terms are each less than some corresponding constant. The modified version of MSCR in Zhang (2010), as discussed in greater detail below, may also be extended in this instance by including multiple non-linear constraints on relaxed regularization terms. In accordance with one embodiment, the iterative thresholding procedure set forth hereinafter, may be modified so as to select thresholds that differ for different parts of the schedule (e.g., for different block faces or for different days) in order to enable the constraints to be satisfied.

It will be appreciated that the full objective (J(p)) 130 may not be concave and that even very simple families of L₀-regularized optimization problems are intractable. Accordingly, iterative thresholding and multi-stage convex relaxation techniques may be used, as set forth below.

Turning now to FIG. 3, there is shown a flow chart 300 corresponding to the optimization of a price schedule (p^{k}) 132 in accordance with the simplicity and welfare functions discussed above with respect to FIG. 2. A maximum number of iterations (k) may be received at 302. Each iteration (k=1 to kₘₐₓ) may use an increasing sequence of thresholds 138, i.e., threshold sequence (τ^{k})_{k=1:k}_{ₘₐₓ}, which may be received at 304. A first iteration may then be initiated at 306, which may correspond to an application of a soft threshold function (initially, A¹=) to the initial price schedule, i.e., (p^{k}) 132:

p^{k}:=argmaxₚ(p)−Σ_{iεA\A}_{^{k}}αᵢg(C(Yⁱp)) subject to Yⁱp=0 for iεA^{k-1}.

A new zero set (A^{k}), i.e., a set of price differences that are constrained to zero may then be determined at 308 (Yⁱp=0, e.g., the difference in price on the schedule 132 with respect to the target schedule 134). That is, at the next iteration, the price differences in set (A^{k}) will not be allowed to vary away from zero, i.e., those price differences are going to be fixed going forward in execution of the systems and methods described hereinafter. The determination at 308 of the new zero set (A^{k}) may be made in accordance with the application of the soft threshold function, such that:

A:={iεA|C(Yⁱp)<τ^{k}}.

Thus, the new zero set (A) after iteration (k) is determined as the set of price differences for which the soft threshold function (C) of the price difference is lower than the value of the threshold sequence for iteration (k). It will be appreciated that selection of a set to zero may be based upon myriad rationales, and the selection herein of the set that are already small relative to zero is for example purposes.

A hard threshold function may then be applied at 310, such that:

p^{uk}:=argmaxₚW(p) subject to Yⁱp=0 for iεA^{k}.

That is, the welfare (W(p)) is maximized with respect to the price schedule (p) subject to the constraint that price differences from the zero set (A^{k}) are exactly zero.

This hard threshold application results in a new price schedule (p^{uk}) determined at 312. The welfare (W) of the new price schedule (p^{uk}) may then be maximized subject to the determined new zero-set (A^{k}) at 314. The full objective 130, defined as welfare function (W(p)) minus all the L₀-regularization terms 136, established above at 214, may then be computed at 316. That is, the full objective (J(p^{uk})) 130 may be computed on the price schedule (p^{uk}) output by the hard threshold steps 224-228, according to the equation:

J^{k}:=W(p^{uk})−Σ_{iεA}αᵢ∥Yⁱp∥₀.

The full objective (J(p^{uk})) 130 may then be compared to the previous computation (if any) at 318. For example, the full objective (J(p^{uk})) 130 may be compared to a previously computed full objective, such as the full objective (J(p^{uk-1})). A determination may then be made at 320 whether the current computation, e.g., (J(p^{uk})) 130 has decreased relative to the previous computation (e.g., (J(p^{uk-1}))). Upon a negative determination at 320, operations may proceed to 322, whereupon iteration to the next thresholds 138 (soft and hard) may occur. Operations then proceed as set forth above with respect to 220 through 320 using the next iteration of threshold functions 138. Upon a positive determination at 320, e.g., when k>1 and j^{k}<j^{k-1}, iterative application of the threshold functions 138 terminate and operations may proceed to 324. At 324, the price schedule 144 (e.g., (p^{uk}) or (p^{uk-1})) which resulted in the greatest full objective over all the iterations, may be output. That is, the price schedule (p) which approximately maximizes welfare (W(p)) minus L₀-regularizations corresponding to ((αᵢ)_{iεA}) 140 and ((Yⁱ)_{iεA}) 142 may be output at 236. According to one embodiment, the price schedule 144 (e.g., (p^{uk}) or (p^{uk-1})) output may be rounded to the nearest dollar or cent as selected by a manager, administrator, or other user associated with the system and methods set forth above.

One example implementation of the methodology discussed above is presented in Algorithm 1. Accordingly, the inputs used herein correspond to the welfare function (W(p)), regularization weights ((αᵢ)_{iεA}) 140, a regularization penalty (g), a transfer function (C), differencing matrices ((Yⁱ)_{iεA}) 142, and the threshold sequence (τ^{k})_{k=1:k}_{ₘₐₓ} 138. In this example implementation, the sequence of thresholds τₖ₊₁:=1.2τₖ can be used. Accordingly, the function can be set such that g(x):=x^{0.2}, following which optimization can be performed using the Matlab® function ƒmincon with Hessian option ‘on’, i.e., a trust-region method.

The implementation of the soft threshold function (306 presented above), including function (C), is discussed below using Algorithm 1:

Algorithm 1

```
1: for k = 1 to kₘₐₓ
2: (Soft threshold step (306). Initially A¹ = ):
  p^{k} := argmaxₚ W(p) − Σ_{iεA\A}_{^{k}} αᵢg (C(Yⁱp)) subject to Yⁱp = 0
  for i ε A^{k-1};
3:  A := {i ε A|C(Yⁱp) < τ^{k}} (New zero-set)
      4:  p^{uk} := argmaxₚ W(p) subject to Yⁱp = 0 for i ε A^{k} (Hard
threshold (310))
5: J ^{k} := W(p^{uk}) − Σ_{iεA} αᵢ∥Yⁱp∥₀ (Computation of full objective (230))
6: if k > 1 and j^{k} < j^{k-1} then break (else return to step 2)
7: end
8: return p^{uk}* where k* := argmax_{1≦i≦k}Jⁱ
```

It will be appreciated that the number constraints may become larger than the total number of variables with the zero-set determined above. It will further be appreciated that a suitable solution may still exist because the constraints are not linearly independent. However, some optimization implementations may present issues in such a situation. Accordingly, all the rows of the hard constraint matrix link a pair of prices, which pair may be viewed as an edge. With this edge interpretation, an equivalent but linearly independent, constraint set may be recovered. In the implementation discussed above, this may be achieved by determining a spanning forest of the zero-set.

According to one example, application of the soft threshold 138 may utilize a version of multi-stage convex relaxation (MSCR). Such an MSCR may include, for example, the MSCR introduced by Zhang (2010). As will be understood, MSCR is a generalization of concave-convex programming (CCCP), local linear approximation (LLA) and local quadratic approximation (LQA). Moreover Zhang (2010) indicates that under suitable conditions, MSCR may produce better results than alternative L₀-optimization techniques.

Essentially, MSCR replaces concave terms in a minimization problem by convex terms, such as L₁- or L₀- (for q>1) terms, which accurately approximate the objective in the vicinity of the current solution estimate. The resulting convex minimization problem is solved and a new iteration begins from the new solution estimate. More specifically, in the context of maximization problems, MSCR may represent a general technique for maximizing functions of the form:

$$W ( p ) - {\sum }_{i = 1}^{n} {R}_{i} ( {h}_{i} ( p ) )$$

where W: [symbol] ^{m}→ [symbol] and Rᵢ: [symbol] ^{m}^{ᵢ}→ [symbol] are concave and where hᵢ: [symbol] ^{m}→ [symbol] ^{m}^{ᵢ}. In detail, MSCR may operate as shown in Algorithm 2:

Algorithm 2
1: vᵢ := 1 for 1 ≦ i ≦ n
2: repeat until convergence
3: p := argmax W(p) − Σᵢ₌₁ⁿ vᵢ^{T}hᵢ(p), subject to any additional linear
constraints on p
4: vᵢ := ∇ᵤRᵢ|ᵤ₌ₕ_{ᵢ}₍ₚ₎ for 1 ≦ i ≦ n
5. end

In accordance with one embodiment, Algorithm 2 may be utilized in implementing step 2 of Algorithm 1 above. That is, described above, step 2 of Algorithm 1 assumes that the simplicity terms were of the form g(C(Yⁱp)) where g(.) and C(.) were scalar functions, i.e., functions with range [symbol] . However, it will be appreciated that it may be useful to work with a more general setting where C(.) is replaced by a vector function h(.), described below. Accordingly, Algorithm 2 describes one example manner in which to implement step 2 of algorithm 1.

The method may set Rᵢ(x):=αᵢ|x|^{r} for some 0≦r≦1 and hᵢ(p):=C(Yⁱp), where C: [symbol] ^{m}^{ᵢ}→ [symbol] is a transfer function for a given parameter (a) (e.g., a=0.1), such that:

$$C ( y ; a ) := a log {\sum }_{i = 1 : {m}_{i}} cosh ( \frac{{y}_{i}}{a} )$$

The function (C) may be selected due to it being smooth and thus suitable for many off-the-shelf optimizers. Additionally, the function (C) presents the approximation Rᵢ(hᵢ(p))=αᵢ|C(Yⁱp)|^{r}≈αᵢ∥Yⁱp∥₀. This approximation may be motivated from the facts that lim_{a→0}C(y; a)=max_{1≦i≦n}|yᵢ| and ∥y∥₀=∥maxⱼ|yᵢ|∥₀. It will be appreciated that the function ∥y∥₀=∥maxⱼ|yᵢ|∥₀ may be used to describe either to have all price differences equal to zero from a group of price differences or to allow all price differences from the group to be non-zero, since it is crucial to allow one of the price differences to be non-zero, as discussed below.

### Example Implementations

### Example 1

The following example presents one optimization procedure on a simplistic parking price schedule problem. It will be appreciated that selection of the following model is intended for ease of explanation.

In this model, demand may be a function of location, indexed by ƒεF, and time indexed by tεT. Time may be measured in hours at half-hour intervals from the beginning of a week, such that:

$$T := \{ 0 , \frac{1}{2} , 1 , \frac{3}{2} , … , {T}_{W} - \frac{1}{2} \} where {T}_{W} := 7 \times 24 \times 2.$$

Correspondingly, a price schedule (p) may have components p_{f,t}. Welfare (W) may have a particularly simple form corresponding to a squared deviation of the price schedule (p) from a target price schedule (y) with components y_{ƒ,t}:

W(p)=−∥p−y∥².

The target of this example was set to the following sinusoid with increasing amplitude for appropriate location-specific amplitudes a_{target,ƒ}:

$${y}_{f , t} := {a}_{target , f} ( 1 + \frac{t}{{T}_{W}} ) sin ( \frac{14 π t}{{T}_{W}} ) .$$

The following simplicity metric (S(p)) may then be associated with any given schedule:

$$S ( p ) := {a}_{one hour} {\sum }_{f ∈ F , t ∈ T} {‖ {p}_{f , t} - {p}_{f , t ⊕ 1} ‖}_{0} + {a}_{half hour} {\sum }_{f ∈ F , t ∈ H} ‖ {p}_{f , t} - {p}_{f , t ⊕ \frac{1}{2}} ‖ + {a}_{face} {\sum }_{f , {f}^{′} ∈ F} {‖ {max}_{t ∈ T} \vert {p}_{f , t} - {p}_{{f}^{′} , t} \vert ‖}_{0} + {a}_{day} {\sum }_{f ∈ F , d ∈ D} {‖ {max}_{t ∈ {T}_{d}} \vert {p}_{f , t} - {p}_{f , t ⊕ 24} \vert ‖}_{0} ,$$

where (a) are non-negative scalars (defined below), (H) denotes the subset of (T) corresponding to hours rather than half-hours, ⊕ denotes clock addition which cycles with the week, (D) is the set of days in a week and (T_{d}) is the subset of times (T) that is in day (d).

In the above-identified example simplicity metric (S(p)) for the parking price schedule (p), a_{one hour} Σ_{ƒεF,tεT}∥p_{ƒ,t}−p_{ƒ,t⊕1}∥₀ represents a complexity cost associated with the number of times a price differs for adjacent hours,

$${Y}^{i} := ( \begin{matrix}- 1 & 1 & 0 & 0 & 0 \\ 0 & - 1 & 1 & 0 & 0 \\ 0 & 0 & - 1 & 1 & 0 \\ 0 & 0 & 0 & - 1 & 1\end{matrix} ) .$$

represents a complexity cost associated with the number of times a price differs for adjacent half hours, a_{ƒace}ΣF_{ƒ,ƒ′εF}∥max_{tεT}|p_{ƒ,t}−p_{ƒ′,t}|∥₀ represents a complexity cost associated with the number of times a price differs for adjacent block faces, and a_{day}Σ_{ƒεF,dεD}∥max_{tεT}_{_{d}}|p_{ƒ,t}−p_{ƒ,t⊕24}|∥₀ represents a complexity cost associated with the number of times a price differs for adjacent days.

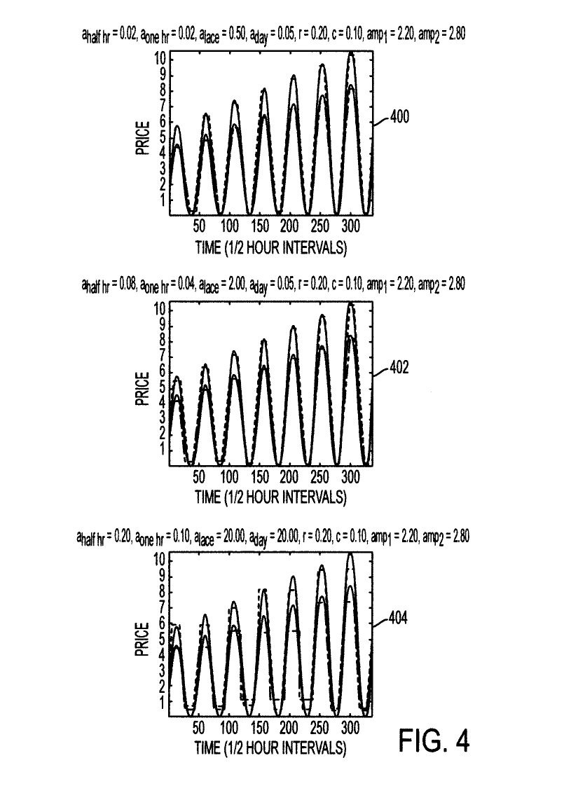

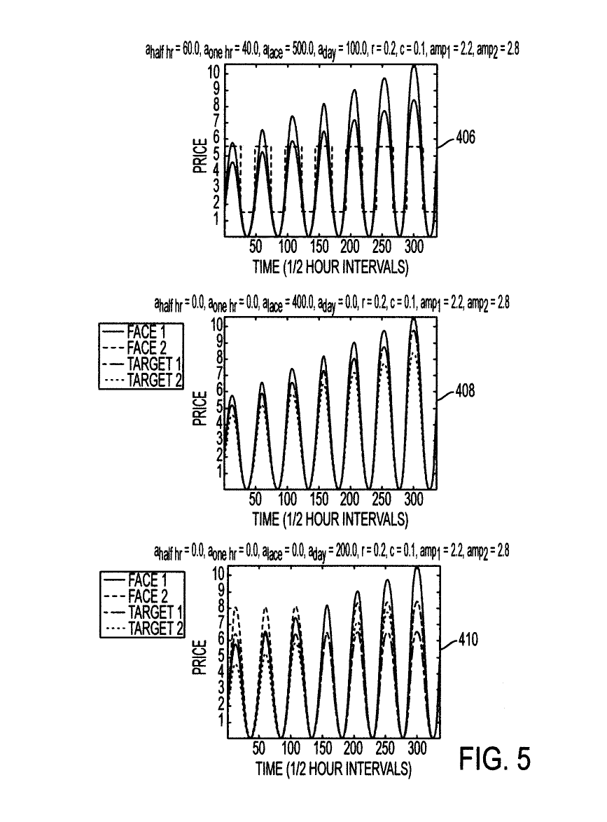

The overall objective may then be to maximize the welfare (W(p)) minus the simplicity metric (S(p)). Plots of price schedules resulting from different selections of parameters (a) are illustrated in the plots 400-410 of FIGS. 4-5 for a two face model. With respect to the aforementioned optimization methodology, it will be appreciated that the multi-stage convex relaxation produces better local minima than other approaches to sparse regularization, while remaining computationally efficient. The usage of iterative thresholding enables the avoidance of the ad hoc and suboptimal step of manually selecting a threshold. Additionally, the transfer function (C) provides a computationally efficient and twice-differentiable surrogate for the maximum absolute difference between two vectors.

The results of low regularization settings are depicted in plot 400. As shown, the plot 400 demonstrates that the results follow the target price schedule (y) closely. In this low regularization illustration, no simplification with respect to the day or the face was performed. A slight simplification was implemented around demand peaks. Data reflecting the occupancy of faces to validate the efficiency of a particular price schedule may be determined by sensors, networked parking meters, parking manager observations or the like. This data may be used, as illustrated in FIGS. 4-5, to verify performance of different price schedules generated in accordance with the systems and methods described above. In the case that data is incomplete, for example, where some of the parking sensors are not reporting whether or not the parking space is occupied, missing data can be inferred, based on the data supplied from working sensors, for example, using the method of U.S. application Ser. No. 13/438,313, filed Apr. 3, 2012, entitled MODEL FOR USE OF DATA STREAMS OF OCCUPANCY THAT ARE SUSCEPTIBLE TO MISSING DATA, by Mihajlo Grbovic, et al., the disclosure of which is incorporated herein by reference in its entirety. Thus, as illustrated in FIGS. 4-5, the welfare (W(p)) is maximized relative to the simplicity metric (S(p)) having different choices of parameters (a). The plot 402 illustrates low-to-moderate regularization settings for all parameters (a) of the example implementation. That is, plot 402 illustrates that no simplification with respect to the day or face were made, and most of the half-hour transitions were eliminated. In contrast, plot 404 illustrates the results of moderate regularization of all parameters (a). Thus, plot 404 includes a small number of half-hour transitions, a substantial flattening occurs at extreme demand, several days are merged for each face and no face merging has occurred.

Plots 406-410 illustrate the effects of varying degrees of high regularization on some or all elements associated with the price schedule. Plot 406 depicts the results of high regularization of all parameters (a). Thus, all days and all faces have been merged, with only two prices per day that change on the hour, i.e., the same face, every day, will only have two differing prices. Plot 408 depicts the results of high regularization of some of the parameters (a) (high face regularization) while other parameters (a) remain low. Thus, plot 408 illustrates the results of merging faces with no other simplification added. In contrast, the parameters (a) of the example implementation, with respect to days, have been highly regularized in the plot 410, while low regularization applies to the remaining parameters (a). That is, plot 410 illustrates that days have been merged for each face, but no other type of simplification has been performed on the price schedule.

### Example 2

The following price schedule is depicted to illustrate a price schedule corresponding to different locations and time intervals. It will be appreciated that other price schedule formats may be used in accordance with the systems and methods described herein, and the price schedule illustrated above is intended solely as an example of one such price schedule.

| Block Face | Period | Price Rate ($/HR) |
|---|---|---|
| 101 N FREMONT AV | 8 AM-11 AM Mon-Fri | 1.0 |
| 101 N FREMONT AV | 11 AM-4 PM Mon-Fri | 1.0 |
| 101 N FREMONT AV | 4 AM-6 PM Mon-Fri | 1.0 |
| 101 N FREMONT AV | 8 AM-6 PM Sat | 1.0 |
| 601 NEW HIGH ST | 8 AM-11 AM Mon-Fri | 1.5 |
| 601 NEW HIGH ST | 11 AM-4 PM Mon-Fri | 2.0 |
| 601 NEW HIGH ST | 4 AM-8 PM Mon-Fri | 1.5 |
| 601 NEW HIGH ST | 8 AM-8 PM Sat | 2.0 |
| 1000 S CROCKER ST | 8 AM-11 AM Mon-Fri | 1.0 |
| 1000 S CROCKER ST | 11 AM-4 PM Mon-Fri | 1.5 |
| 1000 S CROCKER ST | 4 AM-6 PM Mon-Fri | 1.0 |
| 1000 S CROCKER ST | 8 AM-6 PM Sat | 0.5 |

An example of a welfare function (or welfare proxy) in accordance with the various embodiments discussed above may be illustrated as a function of the price schedule that predicts the integral over time of the number of parking spaces for which between 2 and 6 of the 20 closest parking spaces are vacant. Thus, the following table of predictions may be constructed as:

| | | Price | N | In | In |
|---|---|---|---|---|---|
| | | Rate | (Parking | Schedule | Schedule |
| Block Face | Period | ($/HR) | spaces × HRs) | 1 | 2 |
| 101 N FREMONT AV | 8 AM-9 AM | 0.5 | 3.0 | | |
| 101 N FREMONT AV | 8 AM-9 AM | 1.0 | 2.5 | 1 | |
| 101 N FREMONT AV | 8 AM-9 AM | 1.5 | 2.2 | | |
| 101 N FREMONT AV | 8 AM-9 AM | 2.0 | 1.5 | | 1 |
| 101 N FREMONT AV | 9 AM-10 AM | 0.5 | 5.1 | | |
| 101 N FREMONT AV | 9 AM-10 AM | 1.0 | 4.5 | 1 | |
| 101 N FREMONT AV | 9 AM-10 AM | 1.5 | 4.1 | | |
| 101 N FREMONT AV | 9 AM-10 AM | 2.0 | 3.5 | | 1 |
| 101 N FREMONT AV | 10 AM-11 AM | 0.5 | 10.2 | | |
| 101 N FREMONT AV | 10 AM-11 AM | 1.0 | 11.5 | 1 | |
| 101 N FREMONT AV | 10 AM-11 AM | 1.5 | 10.2 | | |
| 101 N FREMONT AV | 10 AM-11 AM | 2.0 | 8.9 | | 1 |
| 101 N FREMONT AV | 11 AM-12 NOON | 0.5 | 6.0 | | |
| 101 N FREMONT AV | 11 AM-12 NOON | 1.0 | 6.3 | | |
| 101 N FREMONT AV | 11 AM-12 NOON | 1.5 | 7.9 | 1 | |
| 101 N FREMONT AV | 11 AM-12 NOON | 2.0 | 9.1 | | 1 |
| 101 N FREMONT AV | 12 NOON-1 PM | 0.5 | 3.1 | | |
| 101 N FREMONT AV | 12 NOON-1 PM | 1.0 | 4.2 | | |
| 101 N FREMONT AV | 12 NOON-1 PM | 1.5 | 6.8 | 1 | |
| 101 N FREMONT AV | 12 NOON-1 PM | 2.0 | 8.9 | | 1 |

where the last two columns are included to simplify reference to the next table and N denotes the predicted sum of spaces on the given block face over the given hour satisfying the condition that “between 2 and 6 of the 20 closest parking spaces are vacant”.

From this table, the corresponding welfare proxy value for a given schedule may be determined by summing column N given the matching prices in the Price Rate column. Thus, two specific values of the welfare function are shown in the following table:

| Block Face | ScheduleID | Schedule | Value of Welfare Function |
|---|---|---|---|
| 101 N FREMONT AV | Schedule1 | 8 AM-11 AM $1.0 | 33.2 (= sum of N where In Schedule1) |
| | | 11 AM-1 PM $1.5 | |
| 101 N FREMONT AV | Schedule2 | 8 AM-1 PM $2.0 | 31.9 (= sum of N where In Schedule2) |

With reference to the previous table, there may be a weight (a) for “having a different price at consecutive hours” equal to 4 units of welfare. This weight is be combined with the following difference vector:

yⁱ:=Yⁱp

where the price rate schedule is given by the column vector:
p=[rate at 8 AM, rate at 9 AM, rate at 10 AM, rate at 11 AM, rate at 12 NOON]^{T},
and the matrix giving differences between adjacent hours is:

$${a}_{half hour} {\sum }_{f ∈ F , t ∈ H} {‖ {p}_{f , t} - {p}_{f , t ⊕ \frac{1}{2}} ‖}_{0}$$

Assuming that the combination of weight with the difference vector is chosen to be the zero norm (i.e. a∥yⁱ∥₀), then the simplicity term, i.e., penalty, of Schedule1 would be 4 and that of Schedule2 would be 0. Hence the value (J) of the welfare-minus-simplicity penalty would be computed as:

J(Schedule1)=33.2−4=29.2, and

J(Schedule2)=31.9−0=31.9.

As demonstrated above, for the choice between Schedule1 and Schedule2, Schedule2 would be preferred over Schedule1.

The systems and methods set forth herein may employ other optimization procedures in accordance with the given objective, i.e., maximizing the welfare (W(p)) with respect to the simplicity of the prices schedule (S(p)). For example, such optimization procedures include graduated non-convexity (described in A. Blake and A. Zisserman. Visual Reconstruction. The MIT Press, pp. 46-50, 1987, and G. Hosein Mohimani, M. Babaie-Zadeh and C. Jutten. A Fast Approach for Overcomplete Sparse Decomposition Based on Smoothed l⁰ Norm. IEEE Trans. Sig. Proc., vol. 57, no. 1, pp. 289-301, 2009), basis pursuit (described in S. S. Chen, D. L. Donoho and M. A. Saunders. Atomic decomposition by basis pursuit. SIAM Journal on Scientific Computing, vol. 20, no. 1, pp. 33-61, 1998), matching pursuit (described in S. Mallat and Z. Zhang. Matching pursuits with time-frequency dictionaries. IEEE Trans. on Signal Proc., vol. 41, no. 12, pp. 3397-3415, 1993), the entirety of which are incorporated by reference herein. According to one particular embodiment, the graduated non-convexity may be incorporated into the methodology set forth above by varying the functions and with iteration count. Furthermore, in place of the trust-region method used above, the system and method may utilize quadratic programming when the welfare is a quadratic function and the regularization terms in MSCR are relaxed to norms. Such an implementation may present the advantage that large-scale commercial Quadratic Programming (QP) solvers can be exploited. Furthermore, even if the welfare is not quadratic, this type of approach may be embedded within the sequential quadratic programming framework.

Additional modifications to the method described above may include altering the selection of function such as the Lorentzian, Charbonnier penalty, and one-minus-Gaussian functions described in D. Sun, S. Roth and M. Black. Secrets of Optical Flow Estimation and Their Principles. Computer Vision and Pattern Recognition (CVPR), IEEE Conference on 13-18 Jun. 2010, pp. 2432-2439, 2010, the entirety of which is incorporated by reference herein. An alternative to using the above-identified functions may include usage of the Euclidean norm, by analogy to the use of the Euclidean norm in the group lasso, as described in M. Yuan and Y. Lin. Model selection and estimation in regression with grouped variables. Journal of the Royal Statistical Society, Series B, vol. 68, no. 1, pp. 49-67, 2006, and J. Friedman, T. Hastie and R. Tibshirani. Applications of the lasso and grouped lasso to the estimation of sparse graphical models. Research Report, Stanford University, pp. 1-22, 2010, the entirety of which are incorporated by reference herein. It will be appreciated that while described herein as applicable to on-street and off-street parking, the systems and methods are also applicable to vehicle rentals, ticket sales, and the like.

The method illustrated in FIGS. 2 and 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like. The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowcharts 200 and 300 shown respectively in FIG. 2 and FIG. 3, can be used to implement the exemplary price schedule optimization method.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for selecting an optimized price schedule, comprising:
providing a simplicity metric for computing a simplicity term based on weighted differences between prices in a price schedule;
providing a welfare function for computing a welfare term corresponding to the price schedule;
for a plurality of price schedules:
evaluating the simplicity term of each price schedule in accordance with the simplicity metric,
computing a welfare term for each price schedule in accordance with the welfare function, and,
determining a difference between the welfare term and the simplicity term for each price schedule; and
outputting an optimized price schedule selected from the plurality of price schedules, the selected one of the plurality of price schedules being selected in accordance with the determined respective differences.

2. The method of claim 1, further comprising:
performing a plurality of iterations, for each iteration:
determining a set of price differences between an initial price schedule and a target schedule which optimize a soft threshold function, the soft threshold function being based on the welfare function for the initial price schedule and simplicity metric for the initial price schedule, subject to a constraint on the set of price differences,
determining a new price schedule by optimizing a hard threshold function that optimizes the welfare function subject to the determined set of price differences, and
computing a value of the new price schedule as a function of the computed welfare term and simplicity term for the new price schedule; and
wherein outputting the optimized price schedule further includes selecting one of the new price schedules, the selected one of the new price schedules being selected based on the values computed over the plurality of the iterations.

3. The method of claim 2, wherein the iterations are continued while the computed value of the new price schedule improves or until a stopping criterion is reached.

4. The method of claim 1, wherein the price schedule comprises a set of matrices, each of the matrices mapping components of first and second dimensions to a price of an item.

5. The method of claim 4, wherein the set of price differences comprises a plurality of vectors of price differences (yⱼⁱ), each vector of price differences being computed for a respective one of a set of difference matrices (Yⁱ)_{iεA} that are computed between the respective matrices of the given price schedule and the target price schedule.

6. The method of claim 5, wherein the simplicity metric is a function of the vectors of price differences (yⱼⁱ) and corresponding weighting coefficients (αᵢ)_{iεA} for each of the difference matrices.

7. The method of claim 6, wherein the weighting coefficients (αᵢ) are variables which are a function of demand for the item.

8. The method of claim 2, wherein the applying of the soft threshold function further comprises applying a regularization penalty to the simplicity metric.

9. The method of claim 2, wherein in the computing the value of the new price schedule as a function of the computed welfare term and simplicity term the differences between the given price schedule and the target schedule are L₀-regularization terms.

10. The method of claim 2, wherein the optimizing of the soft threshold function comprises performing a multi-stage convex relaxation.

11. The method of claim 5, wherein the simplicity metric S(p) is of the form:
S(p)=Σ_{iεA}αᵢ∥Yⁱp∥₀;
wherein:
(Yⁱ) represents the ith difference matrix in the set of the set of difference matrices,
(αᵢ) represents a weighting coefficient for the respective difference matrix,
(p) represents the price schedule, and
∥Yⁱp∥₀ is 0 if the difference vector Yⁱp is 0 and 1 otherwise.

12. The method of claim 11, wherein the computing the value of the new price schedule (J(p)) comprises computing a difference between the welfare function and the simplicity S(p).

13. The method of claim 3, wherein the computing of the value of the new price schedule as a function of the computed welfare term and simplicity term for the new price schedule is subject to at least one constraint.

14. The method of claim 13, wherein the at least one constraint comprises at least one of:
not allowing a specific price change; and
a maximum number of allowed price changes;

15. The method of claim 4, wherein in the simplicity function the weights favor simplicity of the matrices of the price schedule.

16. The method of claim 1, wherein the price schedule is a parking price schedule.

17. The method of claim 4, wherein the price of the item comprises the price of a parking place.

18. The method of claim 17, wherein the dimensions include at least one of the group consisting of arrival time, location, and duration of stay.

19. The method of claim 1, wherein the simplicity metric includes a complexity cost associated with a number times a price differs for adjacent hours, a complexity cost associated with a number times a price differs for adjacent half hours, complexity cost associated with a number of times a price differs for adjacent block faces, and a complexity cost associated with a number of times a rice differs for adjacent days.

20. The method of claim 3, wherein the welfare function is based on a deviation between the price schedule and the target price schedule.

21. The method of claim 20, wherein the welfare function is based on a squared deviation between prices in the price schedule (p) and prices in the target price schedule (y).

22. A system for selecting an optimized price schedule comprising memory which stores instructions for performing the method of claim 1 and a processor in communication with the memory for executing the instructions.

23. A computer program product comprising a non-transitory recording medium storing instructions, which when executed on a computer, causes the computer to perform the method of claim 1.

24. An optimized price schedule selection system, comprising:
a processor;
a simplicity metric component configured for computing a simplicity term based on weighted differences in a price schedule using a simplicity metric;
a welfare component configured for computing a welfare term corresponding to the price schedule using a welfare function, the welfare function representative of a quantification of a price schedule relative to a selected target; and
memory in communication with the processor, which stores instructions which are executed by the processor for:
evaluating the simplicity term of each price schedule of a plurality of price schedules in accordance with the simplicity metric;
computing a welfare term for each price schedule of the plurality of price schedules in accordance with the welfare function;
computing a full objective of each price schedule as a function of the computed welfare term and simplicity term; and
outputting an optimized price schedule corresponding to a price schedule having a highest computed full objective.

25. A method for determining an optimized price schedule, comprising:
providing a simplicity metric for computing a simplicity term based on a price schedule;
providing a welfare function for computing a welfare term corresponding to the price schedule;
selectively optimizing at least one parameter associated with the simplicity metric;
maximizing the welfare term with respect to the simplicity metric having at least one selectively optimized parameter associated therewith; and
outputting a new price schedule associated with the maximized welfare term.

26. The method of claim 23, wherein selectively optimizing at least one parameter includes applying a multi-stage convex relaxation to the simplicity metric.

27. The method of claim 23, wherein the simplicity term comprises a set of L₀-regularization terms.

28. The method of claim 23, wherein the welfare function is of a form corresponding to a deviation of the price schedule from a target price schedule.

29. The method of claim 23, wherein the price schedule is a parking price schedule.
